(19) United States
(12) Patent Application Publication
(10) Pub. No.: US 2020/0377718 A1
(43) Pub. Date: Dec. 3, 2020

(54) PROCESSING AIDS FOR FILLER DISPERSION AND USES THEREOF

(71) Applicant: SABIC GLOBAL TECHNOLOGIES B.V., Bergen op Zoom (NL)

(72) Inventors: Mingcheng GUO, Shanghai (CN); Qin WANG, Shanghai (CN); Shen ZHANG, Shanghai (CN)

(73) Assignee: SABIC GLOBAL TECHNOLOGIES B.V., Bergen op Zoom (NL)

(21) Appl. No.: 16/772,240

(22) PCT Filed: Dec. 12, 2018
(86) PCT No.: PCT/IB2018/059952

§ 371 Date: Jun. 12, 2020

Related U.S. Application Data
(60) Provisional application No. 62/599,282, filed on Dec. 15, 2017.

(51) Int. Cl. C08L 67/02; C08K 7/14; C08K 3/40; C08K 7/06

(52) U.S. Cl. CPC C08L 67/02; C08K 7/14; C08L 69/00; C08K 7/06; C08K 3/40

(57) ABSTRACT

A composition includes about 20 wt % to about 80 wt % of a first resin consisting of polybutylene terephthalate (PBT); about 1 wt % to about 20 wt % of a second resin that is different from the first resin, wherein the second resin does not include polyethylene terephthalate (PET); from about 0.5 wt % to about 10 wt % of a first processing aid; and from about 10 wt % to about 60 wt % of a reinforcing filler. The composition has a tensile modulus of at least 3,000 MPa and a notched Izod impact strength of at least 50 J/m. Methods of making the composition are also described.

### FIELD OF THE DISCLOSURE

The present disclosure relates to polybutylene compositions that have particular utility in electronics applications, and in particular to polybutylene compositions having high strength and ductility properties.

### BACKGROUND OF THE DISCLOSURE

Many consumer electronics applications require components having high modulus and ductility performance. In addition, plastic components to be molded into metal parts should have a low mold shrinkage so that they will be compatible with the metal. Modulus properties of plastic components can be improved by adding fillers, such as glass fiber, to the composition. Glass fiber and many other fillers, however, degrade dielectric properties of the plastics by increasing dielectric constant and dielectric dissipation factor. And while impact modifiers can be added to the plastic to increase ductility, they also reduce modulus properties. Plastics having a good balance of high modulus, low mold shrinkage, high impact performance and low dielectric constant and dielectric dissipation factor are therefore desired in these applications.

High modulus and high ductility polymers currently in use include glass-fiber-filled polycarbonate (PC), glass-fiber-filled polybutylene (PBT), and glass-fiber-filled nylon. Of these, the PC-based materials have good ductility, but lower modulus and flow properties than the PBT and nylon-based materials. In addition, the solvent resistance of PC-based materials may not be as good for certain applications such as nano molding technology (NMT) applications. Moreover, nylon-based materials are sensitive to moisture, which could result in degradation of mechanical performance and dimensional stability of components formed therefrom.

These and other shortcomings are addressed by aspects of the present disclosure.

### SUMMARY

Aspects of the disclosure relate to a composition including about 20 wt % to about 80 wt % of a first resin consisting of polybutylene terephthalate (PBT); about 1 wt % to about 20 wt % of a second resin that is different from the first resin, wherein the second resin does not include polyethylene terephthalate (PET); from about 0.5 wt % to about 10 wt % of a first processing aid; and from about 10 wt % to about 60 wt % of a reinforcing filler. The composition has a tensile modulus of at least 3,000 MPa and a notched Izod impact strength of at least 50 J/m.

Aspects of the disclosure further relate to a method of making a composition, the method including forming a resin mixture and injection molding or extruding the resin mixture to form the composition. The resin mixture includes: about 20 wt % to about 80 wt % of a first resin consisting of polybutylene terephthalate (PBT); about 1 wt % to about 20 wt % of a second resin that is different from the first resin, wherein the second resin does not include polyethylene terephthalate (PET); from about 0.5 wt % to about 10 wt % of a first processing aid; and from about 10 wt % to about 60 wt % of a reinforcing filler. The composition includes a tensile modulus of at least 3,000 MPa and a notched Izod impact strength of at least 50 J/m.

### DETAILED DESCRIPTION

The present disclosure can be understood more readily by reference to the following detailed description of the disclosure and the Examples included therein. In various aspects, the present disclosure pertains to compositions including: about 20 wt % to about 80 wt % of a first resin consisting of polybutylene terephthalate (PBT); about 1 wt % to about 20 wt % of a second resin that is different from the first resin; from about 0.5 wt % to about 10 wt % of a first processing aid; and from about 10 wt % to about 60 wt % of a reinforcing filler. The second resin does not include polyethylene terephthalate (PET), and the composition has a tensile modulus of at least 3,000 megapascals (MPa) and a notched Izod impact strength of at least 50 Joule per meter (J/m).

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate” includes mixtures of two or more polycarbonate polymers.

As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated 10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted imide” means that the imide group can or cannot be substituted and that the description includes both substituted and unsubstituted imide groups.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

As used herein, the terms “number average molecular weight” or “Mn” can be used interchangeably, and refer to the statistical average molecular weight of all the polymer chains in the sample and is defined by the formula:

$${M}_{n} = \frac{Σ {N}_{i} {M}_{i}}{Σ {N}_{i}} ,$$

where Mi is the molecular weight of a chain and Ni is the number of chains of that molecular weight. Mn can be determined for polymers, e.g., polycarbonate polymers, by methods well known to a person having ordinary skill in the art using molecular weight standards, e.g. polycarbonate standards or polystyrene standards, preferably certified or traceable molecular weight standards.

As used herein, the terms “weight average molecular weight” or “Mw” can be used interchangeably, and are defined by the formula:

$${M}_{w} = \frac{Σ {N}_{i} {M}_{i}^{2}}{Σ {N}_{i} {M}_{i}} ,$$

where Mi is the molecular weight of a chain and Ni is the number of chains of that molecular weight. Compared to Mn, Mw takes into account the molecular weight of a given chain in determining contributions to the molecular weight average. Thus, the greater the molecular weight of a given chain, the more the chain contributes to the Mw. Mw can be determined for polymers, e.g., polycarbonate polymers, by methods well known to a person having ordinary skill in the art using molecular weight standards, e.g., polycarbonate standards or polystyrene standards, preferably certified or traceable molecular weight standards.

The terms “residues” and “structural units”, used in reference to the constituents of the polymers, are synonymous throughout the specification.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### High Strength and High Ductility Compositions

Aspects of the disclosure relate to a composition including: about 20 wt % to about 80 wt % of a first resin consisting of polybutylene terephthalate (PBT); about 1 wt % to about 20 wt % of a second resin that is different from the first resin; from about 0.5 wt % to about 10 wt % of a first processing aid; and from about 10 wt % to about 60 wt % of a reinforcing filler. The second resin does not include polyethylene terephthalate (PET). The composition has a tensile modulus of at least 3,000 MPa and a notched Izod impact strength of at least 50 J/m.

The PBT may in some aspects be a low viscosity PBT, a high viscosity PBT, or a combination thereof. The low viscosity PBT may in some aspects have an intrinsic viscosity of about 0.66 cubic centimeters per gram (cm³/g) as measured in 60:40 phenol/tetrachloroethane. The high viscosity PBT may in some aspects have an intrinsic viscosity of about 1.2 cm³/g as measured in 60:40 phenol/tetrachloroethane. Second polymers, copolymers and/or homopolymers may also be included with the PBT component in various compositions in accordance with aspects of the present disclosure.

The second resin includes in certain aspects polycarbonate (PC), polyetherimide (PEI), PEI-siloxane copolymer, a resorcinol-based aryl polyester having at least 40 mole % of its moieties derived from resorcinol, copolymers thereof or a combination thereof.

As used herein, polybutylene terephthalate can be used interchangeably with poly(1,4-butylene terephthalate). Polybutylene terephthalate is one type of polyester. Polyesters, which include poly(alkylene dicarboxylates), liquid crystalline polyesters, and polyester copolymers, can be useful in the disclosed thermoplastic compositions of the present disclosure.

As used herein, polycarbonate refers to an oligomer or polymer including residues of one or more dihydroxy compounds, e.g., dihydroxy aromatic compounds, joined by carbonate linkages; it also encompasses homopolycarbonates, copolycarbonates, and (co)polyester carbonates.

As used herein, “polyetherimide” refers to polymers containing ether and optionally substituted imide functional groups in the backbone of the polymer.

As used herein, polyethylene terephthalate can be used interchangeably with poly(ethyl benzene-1,4-dicarboxylate). As with polybutylene terephthalate, polyethylene terephthalate is a type of polyester.

As used herein, “polyester” refers to a polymer containing an ester functional group in the backbone of the polymer.

The resorcinol-based aryl polyester is a copolymer containing non-resorcinol-based moieties, for instance a resorcinol-bisphenol-A copolyester carbonate. In certain aspects, the resorcinol moiety content (RMC) can be greater than about 40 mole % of the total monomer-derived moieties present in the resorcinol-based aryl polyester. In some instances RMC of greater than 50 mole %, such as 60 mole %, 70 mole %, 80 mole %, 90 mole %, or 100 mole % resorcinol moieties may be desired.

In some aspects the first processing aid includes a low molecular weight ionomer. The low molecular weight ionomer may include an olefin backbone with one or more substituted salt groups attached to the olefin backbone; the one or more salt groups include a carboxylate or sulphonate; and the one or more salt groups are substituted with at least one metal cation. The metal cation in some aspects is sodium, zinc, lithium, potassium, magnesium, calcium, barium, copper or a combination thereof. In particular aspects the first processing aid may include an ethylene-acrylic acid zinc ionomer. One such ionomer is AClyn® 295, available from Honeywell. It is believed that the inclusion of the first processing aid reduces mold shrinkage, makes mold shrinkage more uniform, provides the composition with improved impact performance and/or improves the dielectric properties of the composition.

Compositions according to aspects of the disclosure include a reinforcing filler. The reinforcing filler may include a flat, plate-like, and/or fibrous filler. Typically, the flat, plate-like filler has a length and width at least ten times greater than its thickness, where the thickness is from 1 to 1000 micrometers. Exemplary reinforcing fillers of this type include glass flakes, mica, flaked silicon carbide, aluminum diboride, aluminum flakes, and steel flakes; wollastonite including surface-treated wollastonite; calcium carbonate including chalk, limestone, marble and synthetic, precipitated calcium carbonates, generally in the form of ground particulates; talc, including fibrous, modular, needle shaped, and lamellar talc; kaolin, including hard, soft, calcined kaolin, and kaolin including various coatings known in the art to facilitate compatibility with the polymeric matrix polymer; mica; and feldspar. Exemplary reinforcing fillers also include fibrous fillers such as short inorganic fibers, natural mineral fibrous fillers, single crystal fibers, glass fibers, ceramic fibers and organic reinforcing fibrous fillers. Short inorganic fibers include borosilicate glass, carbon fibers, and those derived from blends including at least one of aluminum silicates, aluminum oxides, magnesium oxides, and calcium sulfate hemihydrate. Single crystal fibers or “whiskers” include silicon carbide, alumina, boron carbide, iron, nickel, and copper single crystal fibers. Glass fibers, including glass fibers such as E, ECR, S, and NE glasses and quartz and the like can also be used. In particular aspects the reinforcing filler includes glass fiber, carbon fiber, basalt fiber or a combination thereof.

The amount of reinforcing filler used in the compositions can vary widely, and is that amount effective to provide the desired physical properties. In some aspects, the reinforcing filler is present in an amount from about 10 wt % to 60 wt %, more specifically 15 to 40 wt %, and even more specifically 20 to 30 wt %, each based on the total weight of the composition.

The composition may include in some aspects an impact modifier, a third polymer, or a combination thereof. The impact modifier and/or third polymer may include polyester ether elastomer, ethylene-glycidyl methacrylate copolymer (EGMA), ethylene-methyl acrylate with glycidyl methacrylate (EMAGMA), ethylene ethyl acrylate, polyethylene (PE), polypropylene (PP), polystyrene (PS), poly(p-phenylene oxide) (PPO), acrylonitrile butadiene styrene (ABS), styrene-ethylene-butadiene-styrene (SEBS), copolymers thereof, or a combination thereof. The impact modifier and/or third polymer may be present in an amount of from greater than 0 wt % to about 20 wt %, based on the total weight of the composition.

Aspects of the composition further include a reinforcing agent and/or and additional additive. The composition may include from greater than 0 wt % to about 30 wt % of the reinforcing agent and/or additional additive. The reinforcing agent may include, but is not limited to, glass beads, hollow glass beads, mineral fillers, or a combination thereof. Exemplary mineral fillers include, but are not limited to, titanium dioxide, talc, mica, zinc sulfide, wollastonite, clay, or a combination thereof. The additional additive may include, but is not limited to, a pigment, a second processing aid (e.g., a flow promoter and/or a de-molding agent), a thermal stabilizer, a light stabilizer, an ultraviolet (UV)-resistance additive, a UV-absorbing additive, or a combination thereof.

Compositions according to aspects of the disclosure have a tensile modulus of at least 3,000 MPa. In some aspects the composition has a tensile modulus of from about 3,000 MPa to about 15,000 MPa, or in particular aspects from about 3,000 MPa to about 12,500 MPa, or from about 8,000 MPa to about 12,500 MPa, or greater than about 8,000 MPa, or greater than about 9,000 MPa, or greater than about 10,000 MPa. Tensile modulus may be determined in accordance with ASTM D638.

Compositions according to aspects of the disclosure have a notched Izod impact (NII) strength of at least 50 J/m. In some aspects the composition has a NII strength of from about 50 J/m to about 150 J/m, or in particular aspects from about 50 J/m to about 120 J/m, or from about 75 J/m to about 120 J/m, or greater than 75 J/m, or greater than 100 J/m. Notched Izod impact strength may be determined according to ASTM D256.

The PBT-based compositions including the first processing aid, reinforcing filler and second resin that does not include PET—as described herein—have a good balance of properties, including high modulus, enhanced ductility, reduced mold shrinkage, more uniform mold shrinkage, and good dielectric properties.

### Methods of Manufacture

The one or any foregoing components may be first dry blended with each other, or dry blended with any combination of foregoing components, then fed into an extruder from one or multi-feeders, or separately fed into an extruder from one or multi-feeders. The fillers used in the invention may also be first processed into a masterbatch, then fed into an extruder. The components may be fed into the extruder from a throat hopper or any side feeders.

The extruders used in the invention may have a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, co-kneaders, disc-pack processors, various other types of extrusion equipment, or combinations including at least one of the foregoing.

The components may also be mixed together and then melt-blended to form the compositions. The melt blending of the components involves the use of shear force, extensional force, compressive force, ultrasonic energy, electromagnetic energy, thermal energy or combinations including at least one of the foregoing forces or forms of energy.

The barrel temperature on the extruder during compounding can be set at the temperature where at least a portion of the polycarbonate has reached a temperature greater than or equal to about the melting temperature, if the resin is a semi-crystalline organic polymer, or the flow point (e.g., the glass transition temperature) if the resin is an amorphous resin.

The mixture including the foregoing mentioned components may be subject to multiple blending and forming steps if desirable. For example, the moldable composition may first be extruded and formed into pellets. The pellets may then be fed into a molding machine where it may be formed into any desirable shape or product. Alternatively, the moldable composition emanating from a single melt blender may be formed into sheets or strands and subjected to post-extrusion processes such as annealing, uniaxial or biaxial orientation.

### Articles of Manufacture

In certain aspects, the present disclosure pertains to shaped, formed, or molded articles including the compositions described herein. The compositions can be molded into useful shaped articles by a variety of means such as injection molding, extrusion molding, rotational molding, blow molding and thermoforming to form articles and structural components of, for example, personal or commercial electronics devices, including but not limited to cellular telephones, tablet computers, personal computers, notebook and portable computers, and other such equipment, medical applications, RFID applications, automotive applications, and the like. In a further aspect, the article is extrusion molded. In a still further aspect, the article is injection molded.

Various combinations of elements of this disclosure are encompassed by this disclosure, e.g., combinations of elements from dependent claims that depend upon the same independent claim.

### Aspects of the Disclosure

In various aspects, the present disclosure pertains to and includes at least the following aspects.

Aspect 1. A composition comprising, consisting of, or consisting essentially of:

a. about 20 wt % to about 80 wt % of a first resin consisting of polybutylene terephthalate (PBT);

b. about 1 wt % to about 20 wt % of a second resin that is different from the first resin, wherein the second resin does not comprise polyethylene terephthalate (PET);

c. from about 0.5 wt % to about 10 wt % of a first processing aid; and

d. from about 10 wt % to about 60 wt % of a reinforcing filler, wherein the composition comprises a tensile modulus of at least 3,000 MPa and a notched Izod impact strength of at least 50 J/m.

Aspect 2. The composition according to Aspect 1, wherein the PBT is a low viscosity PBT, a high viscosity PBT, or a combination thereof.

Aspect 3. The composition according to Aspects 1 or 2, wherein the second resin comprises polycarbonate (PC), polyetherimide (PEI), PEI-siloxane copolymer, a resorcinol-based aryl polyester having at least 40 mole % of its moieties derived from resorcinol, copolymers thereof or a combination thereof.

Aspect 4. The composition according to any of Aspects 1 to 3, wherein the first processing aid comprises a low molecular weight ionomer.

Aspect 5. The composition according to Aspect 4, wherein: the low molecular weight ionomer comprises an olefin backbone with one or more substituted salt groups attached to the olefin backbone; the one or more salt groups comprise a carboxylate or sulphonate; and the one or more salt groups are substituted with at least one metal cation.

Aspect 6. The composition according to Aspect 5, wherein the at least one metal cation is selected from the group consisting of sodium, zinc, lithium, potassium, magnesium, calcium, barium, copper and combinations thereof.

Aspect 7. The composition according to any of Aspects 1 to 6, wherein the reinforcing filler comprises glass fiber, carbon fiber, basalt fiber or a combination thereof.

Aspect 8. The composition according to any of Aspects 1 to 7, further comprising from greater than 0 wt % to about 20 wt % of an impact modifier, a third polymer, or a combination thereof.

Aspect 9. The composition according to Aspect 8, wherein the impact modifier and the third polymer comprise one or more of polyester ether elastomer, ethylene-glycidyl methacrylate copolymer (EGMA), ethylene-methyl acrylate with glycidyl methacrylate (EMAGMA), ethylene ethyl acrylate, polyethylene (PE), polypropylene (PP), polystyrene (PS), poly(p-phenylene oxide) (PPO), acrylonitrile butadiene styrene (ABS), styrene-ethylene-butadiene-styrene (SEBS), copolymers thereof, or a combination thereof.

Aspect 10. The composition according to any of Aspects 1 to 9, further comprising from greater than 0 wt % to about 30 wt % of a reinforcing agent or additional additive.

Aspect 11. The composition according to Aspect 10, wherein the reinforcing agent comprises solid glass beads, hollow glass beads, mineral fillers, or a combination thereof.

Aspect 12. The composition according to Aspect 11, wherein the mineral fillers comprise titanium dioxide, talc, mica, zinc sulfide, wollastonite, clay, or a combination thereof.

Aspect 13. The composition according to any of Aspects 10 to 12, wherein the additional additive comprises a pigment, a second processing aid, a thermal stabilizer, a light stabilizer, an ultraviolet (UV)-resistance additive, a UV-absorbing additive, or a combination thereof.

Aspect 14. The composition according to Aspect 13, wherein the second processing aid comprises a flow promoter, a de-molding agent or a combination thereof.

Aspect 15. An article formed from the composition of any of Aspects 1 to 14.

Aspect 16. The article according to Aspect 15, wherein the article is injection molded or extrusion molded.

Aspect 17. The article of Aspect 15 or 16, wherein the article is a molded article.

Aspect 18. A method of making a composition, the method comprising, consisting of, or consisting essentially of:

a. forming a mixture comprising
i. about 20 wt % to about 80 wt % of a first resin consisting of polybutylene terephthalate (PBT),
ii. about 1 wt % to about 20 wt % of a second resin that is different from the first resin, wherein the second resin does not comprise polyethylene terephthalate (PET),
iii. from about 0.5 wt % to about 10 wt % of a first processing aid, and
iv. from about 10 wt % to about 60 wt % of a reinforcing filler; and

b. injection molding or extruding the mixture to form the composition, wherein the composition comprises a tensile modulus of at least 3,000 MPa and a notched Izod impact strength of at least 50 J/m.

Aspect 19. The method according to Aspect 18, wherein the PBT is a low viscosity PBT, a high viscosity PBT, or a combination thereof.

Aspect 20. The method according to Aspects 18 or 19, wherein the second resin comprises polycarbonate (PC), polyetherimide (PEI), PEI-siloxane copolymer, a resorcinol-based aryl polyester having at least 40 mole % of its moieties derived from resorcinol, copolymers thereof or a combination thereof.

Aspect 21. The method according to any of Aspects 18 to 20, wherein the first processing aid comprises a low molecular weight ionomer.

Aspect 22. The method according to Aspect 21, wherein: the low molecular weight ionomer comprises an olefin backbone with one or more substituted salt groups attached to the olefin backbone; the one or more salt groups comprise a carboxylate or sulphonate; and the one or more salt groups are substituted with at least one metal cation.

Aspect 23. The method according to Aspect 22, wherein the at least one metal cation is selected from the group consisting of: sodium, zinc, lithium, potassium, magnesium, calcium, barium, copper and combinations thereof.

Aspect 24. The method according to any of Aspects 18 to 23, wherein the reinforcing filler comprises glass fiber, carbon fiber, basalt fiber or a combination thereof.

Aspect 25. The method according to any of Aspects 18 to 24, further comprising from greater than 0 wt % to about 20 wt % of an impact modifier, a third polymer, or a combination thereof.

Aspect 26. The method according to Aspect 25, wherein the impact modifier and the third polymer comprise one or more of polyester ether elastomer, ethylene-glycidyl methacrylate copolymer (EGMA), ethylene-methyl acrylate with glycidyl methacrylate (EMAGMA), ethylene ethyl acrylate, polyethylene (PE), polypropylene (PP), polystyrene (PS), poly(p-phenylene oxide) (PPO), acrylonitrile butadiene styrene (ABS), styrene-ethylene-butadiene-styrene (SEBS), copolymers thereof, or a combination thereof.

Aspect 27. The method according to any of Aspects 18 to 26, further comprising from greater than 0 wt % to about 30 wt % of a reinforcing agent or additional additive.

Aspect 28. The method according to Aspect 27, wherein the reinforcing agent comprises solid glass beads, hollow glass beads, mineral fillers, or a combination thereof.

Aspect 29. The method according to Aspect 28, wherein the mineral fillers comprise titanium dioxide, talc, mica, zinc sulfide, wollastonite, clay, or a combination thereof.

Aspect 30. The method according to any of Aspects 27 to 29, wherein the additional additive comprises a pigment, a second processing aid, a thermal stabilizer, a light stabilizer, an ultraviolet (UV)-resistance additive, a UV-absorbing additive, or a combination thereof.

Aspect 31. The method according to Aspect 30, wherein the second processing aid comprises a flow promoter, a de-molding agent or a combination thereof.

Aspect 32. An article formed from the method of any of Aspects 18 to 31.

Aspect 33. The article according to Aspect 32, wherein the article is injection molded or extrusion molded.

Aspect 34. The article of Aspect 32 or 33, wherein the article is a molded article.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Compositions were prepared by a twin-screw extruder compounding process and an injection molding process under conventional polymer processing conditions. In particular a Twin screw extruder (Toshiba TEM-37BS, L/D=40.5) was used with the temperature of the extruder barrel set at 245° C. Pellets extruded from extruder were then injection molded into different standard mechanical properties testing bars.

Tensile data was obtained according to ASTM D638; Flexural data was obtained according to ASTM 790; Notched Izod Impact (NII) and Unnotched Izod Impact (UNNI) data were obtained according to ASTM D256 and ASTM D4812 respectively; Density data was obtained according to ASTM D792. NII and UNNI properties were tested at room temperature.

Table 1 shows the raw materials that the experiments used.

TABLE 1
Component List

| Component | Description | Supplier | CAS# |
|---|---|---|---|
| PBT1 | PBT, 1200-211D, | Changchun | 26062-94-2 |
| | low IV | Plastic | |
| | | Co., Ltd. | |
| PBT2 | Resin, PBT, High | Changchun | 26062-94-2 |
| | Viscosity, 1100X | Plastic | |
| | | Co., Ltd. | |
| PC1 | Resin, polymer from | SABIC | 235420-85-6 |
| | resorcinol, bisphenol | | |
| | A, p-cumylphenol, | | |
| | DAC, and phosgene, | capped | |
| | SLX 90/10 | | |
| | PCP 20M powder | | |
| | (polycarbonate | | |
| | copolymer) | | |
| PC2 | Low Fries PC 102X, | SABIC | 111211-39-3 |
| | FG102L-11204- | | |
| | 0-40BD, lot | | |
| | L11994 (High Mw) | | |
| | (melt polycarbonate) | | |
| PEI | ULTEM ™ 1040 | SABIC | 61128-46-9 |
| | Resin CU999 | | |
| PET | Resin, low IV PET IV | DuPont | 25038-59-9 |
| | 0.555-0.575, Crystar | | |
| | 3947-635 (Polyethylene | | |
| | terephthalate (PET)) | | |
| PPC | C016 PPC resin, | SABIC | 71519-80-7 |
| | ML5541-110001, | | |
| | polyestercarbonate | | |
| | resin | | |
| PCE | Poly (carbonate ester) | SABIC | 114096-64-9 |
| | 60% Low MW, | | |
| | RL6829-111N | | |
| ION | AClyn ® Ethylene- | Honeywell | 28208-80-2 |
| | Acrylic | | |
| | Acid Zinc Ionomers, | | |
| | AClyn ® 295 | | |
| MZP | Quencher, Mono zinc | Budenheim | 13598-37-3 |
| | phosphate, Z21-82 | Iberica, | |
| | | S.L. Soc. en | |
| | | Comandita | |
| IRG | Thermo-stabilizer, | | |
| | Hindered phenol, | | |
| | Irganox ® 1010 | | |
| PETS | Pentaerythritol | FACT Asia | 115-83-3 |
| | tetrastearate | Pacific | |
| | | Pte Ltd. | |
| STAB1 | 2-(2′ hydroxy-5-T- | BASF | 3147-75-9 |
| | Octylphenyl)- | | |
| | Benzotriazole, | | |
| | Tinuvin ® | | |
| | 329 (stabilizer) | | |
| STAB2 | Coated TiO₂ Kronos ® | Kronos | 13463-67-7 |
| | 2233 (stabilizer) | | |
| GF | CPIC 10 um GF | CPIC | 65997-17-3 |
| IM | IM, terpolymer: | Arkema Inc. | 51541-08-3 |
| | ethylene-methyl | | |
| | acrylateglycidyl - | | |
| | methacrylate, | | |
| | Lotader ® AX | 8900 | |
| HYT | Polyester elastomer, | DuPont | 61987-75-5 |
| | HYT4056 | | |
| EEA | Ethylene-ethyl Acrylate | Dow | 9010-86-0 |
| | (EEA) Copolymer, | | |
| | AMPLIFY ™ | EA 102 | |
| COL1 | Colorant, Carbon | Cabot | 1333-86-4 |
| | black, M800 | | |
| COL2 | Colorant, ZnS | Sachtolith | 1314-98-3 |
| | | HD-S | |
| WOL | Wollastonite 4W | NYCO | 13983-17-0 |
| | 10992 | | |

Example screening (S) compositions including PBT were prepared with various second polymers, including PET, PPC, PCE, PC and PEI. Tensile, flexural, impact strength and mold shrinkage properties (among others) were evaluated on the screening compositions. The compositions that were formed and their relevant properties are shown in Table 2. Examples S7 and S8 are prior art compositions that include only PBT; example S1 substituted additional PBT for a second polymer.

TABLE 2
Screening examples for second resin

| Component/Property | Unit | S1 | S2 | S3 | S4 | S5 | S6 | S7 | S8 |
|---|---|---|---|---|---|---|---|---|---|
| PBT1 | % | 74.4 | 74.4 | 74.4 | 74.4 | 74.4 | 74.4 | 74.4 | 74.4 |
| PBT1 | % | 25 | | | | | | | |
| PET | % | | 25 | | | | | | |
| PPC | % | | | 25 | | | | | |
| PCE | % | | | | 25 | | | | |
| PC1 | % | | | | | 25 | | | |
| PEI | % | | | | | | 25 | | |
| IRG | % | 0.1 | 0.1 | 0.1 | 0.1 | 0.1 | 0.1 | 0.1 | 0.1 |
| STAB1 | % | 0.25 | 0.25 | 0.25 | 0.25 | 0.25 | 0.25 | 0.25 | 0.25 |
| MZP | % | 0.05 | 0.05 | 0.05 | 0.05 | 0.05 | 0.05 | 0.05 | 0.05 |
| PETS | % | 0.2 | 0.2 | 0.2 | 0.2 | 0.2 | 0.2 | 0.2 | 0.2 |
| COL2 | % | | | | | | | 25 | |
| STAB2 | % | | | | | | | | 25 |
| Total: | | 100.0 | 100.0 | 100.0 | 100.0 | 100.0 | 100.0 | 100.0 | 100.0 |
| Flexural Modulus | MPa | 2440 | 2640 | 2250 | 2230 | 2380 | 2620 | 2970 | 2840 |
| (Avg) | | | | | | | | | |
| Flexural Stress at | MPa | 88.1 | 86.4 | 85.6 | 78.9 | 89.2 | 93 | 87.2 | 87.8 |
| Yield (Avg) | | | | | | | | | |
| NII (room temp) | J/m | 28.1 | 18.4 | 30.1 | 42.4 | 35.5 | 20.8 | 20.8 | 25.9 |
| (Avg) | | | | | | | | | |
| UNII (room | J/m | 551 | 329 | 251 | 374 | 767 | 141 | 341 | 611 |
| temp) (Avg) | | | | | | | | | |
| HDT (1.82 MPa, | ° C. | 54.5 | 54.7 | 51 | 47.9 | 58.5 | 67.4 | 59.4 | 63.7 |
| 3.2 mm) | | | | | | | | | |
| Mold shrinkage | % | 1 | 0.92 | 0.67 | 0.75 | 0.73 | 0.47 | 1.04 | 0.96 |
| parallel (Avg) | | | | | | | | | |
| Mold shrinkage | % | 0.9 | 0.89 | 0.53 | 0.46 | 0.39 | 0.52 | 0.9 | 0.85 |
| perpendicular | | | | | | | | | |
| (Avg) | | | | | | | | | |

From the data it was observed that mold shrinkage for the composition including PET (S2) was unacceptably high—close to that of the composition including only PBT (S1). In contrast, mold shrinkage for the compositions including PPC (S3), PCE (S4), PC (S5) and PEI (S6) was substantially lower. Mold shrinkage for the prior art compositions (S7 and S8) was similar to that of S1 and S2. No clear trend in the other noted properties was observed. Based on the adverse mold shrinkage data, PET was excluded from further consideration as the second polymer.

Table 3 shows the comparative examples that embody aspects of the disclosure. C1 to C4 are the comparative reference examples. E1 and E2 are example compositions according to aspects of the disclosure.

C1 and C2 compare compositions including an Ethylene-Acrylic Acid Zinc Ionomer. Although the impact performance shows minor improvement and dielectric performance is improved, both compositions have high mold shrinkage.

In C3, some LEXAN™ SLX was added. Compared to C1, it is evident that modulus (tensile and flexural), stress and HDT all dropped. The reduction in properties be related to the drop of PBT crystallinity. As shown, one advantage of SLX addition was the improvement of mold shrinkage.

Both the SLX and some ionomer were added in E1 and E2, where it was observed that the modulus (tensile and flexural), stress, HDT all recovered to some extent. In addition, the impact strength, mold shrinkage and dielectric properties were further improved.

C4 shows a typical composition with a polyester impact modifying package. Comparing C4 and E1/E2, it is seen that modulus (tensile and flexural), stress, HDT, mold shrinkage, dielectric properties were improved in the example compositions (E1 and E2) compared to the conventional composition (C4).

TABLE 3
PC copolymer as second resin with and without ionomer

| Component/Property | Unit | C1 | C2 | C3 | E1 | E2 | C4 |
|---|---|---|---|---|---|---|---|
| PBT1 | % | 69.2 | 66.2 | 54.2 | 51.2 | 49.2 | 46.7 |
| PC1 | % | | | 15 | 15 | 15 | 15 |
| MZP | % | 0.1 | 0.1 | 0.1 | 0.1 | 0.1 | 0.1 |
| IRG | % | 0.1 | 0.1 | 0.1 | 0.1 | 0.1 | 0.1 |
| PETS | % | 0.2 | 0.2 | 0.2 | 0.2 | 0.2 | 0.2 |
| ION | % | | 3 | | 3 | 5 | |
| IM | % | | | | | | 3 |
| HYT | % | | | | | | 2.5 |
| EEA | % | | | | | | 2 |
| COL1 | % | 0.4 | 0.4 | 0.4 | 0.4 | 0.4 | 0.4 |
| GF | % | 30 | 30 | 30 | 30 | 30 | 30 |
| Total: | | 100.00 | 100.00 | 100.00 | 100.00 | 100.00 | 100.00 |
| DK at 1.9 GHz (0.75 | | 3.513 | 3.380 | 3.577 | 3.600 | 3.503 | 3.587 |
| mm thick part) | | | | | | | |
| DF at 1.9 GHz (0.75 mm | | 0.0095 | 0.0085 | 0.0095 | 0.0087 | 0.0087 | 0.0132 |
| thick part) | | | | | | | |
| MVR (Avg) | cm³/10 | 116.0 | 124.1 | 76.6 | 49.7 | 29.6 | 31.4 |
| (275 C./5 kg/300 C.) | min | | | | | | |
| Tensile Modulus (Avg) | MPa | 9372 | 9215 | 8819 | 9102 | 8790 | 7363 |
| Stress at Break (Avg) | MPa | 123.7 | 119.2 | 113.3 | 124.6 | 120.4 | 96.9 |
| Elongation at Break | % | 2.4 | 2.4 | 2.0 | 2.2 | 2.3 | 2.5 |
| (Avg) | | | | | | | |
| Flexural Modulus (Avg) | MPa | 8580 | 8380 | 7950 | 8200 | 7990 | 6410 |
| Flexural Stress at Yield | MPa | 189 | 187 | 176 | 194 | 186 | 144 |
| (Avg) | | | | | | | |
| Flexural Stress at Break | MPa | 185 | 184 | 173 | 190 | 183 | 141 |
| (Avg) | | | | | | | |
| Ductility | % | 0 | 0 | 0.00 | 100 | 100 | 100 |
| NII (room temp) (Avg) | J/m | 71.2 | 84.4 | 80.8 | 108 | 117 | 139 |
| Ductility | % | 0 | 0 | 0.00 | 0.00 | 0.00 | 0.00 |
| UNII (room temp) (Avg) | J/m | 671 | 750 | 696 | 959 | 889 | 653 |
| SG | | 1.54 | 1.52 | 1.52 | 1.51 | 1.49 | 1.40 |
| HDT (1.82 MPa, 3.2 | ° C. | 205 | 206 | 171 | 185 | 183 | 150 |
| mm) | | | | | | | |
| Mold shrinkage parallel | % | 0.31 | 0.34 | 0.14 | 0.18 | 0.23 | 0.12 |
| (Avg) | | | | | | | |
| Mold shrinkage | % | 0.71 | 0.75 | 0.50 | 0.34 | 0.36 | 0.44 |
| perpendicular (Avg) | | | | | | | |

Table 4 shows one more example E3, in which SLX was replaced with a melt polycarbonate. It was observed that the modulus (tensile and flexural), stress, HDT and dielectric properties were further improved, with only the mold shrinkage increasing slightly.

TABLE 4
Comparison of PC copolymer to melt PC (second resin)

| Component/Property | Unit | C1 | C2 | E1 | E3 |
|---|---|---|---|---|---|
| PBT1 | % | 69.2 | 66.2 | 51.2 | 51.2 |
| PC2 | % | | | | 15 |
| PC1 | % | | | 15 | |
| MZP | % | 0.1 | 0.1 | 0.1 | 0.1 |
| IRG | % | 0.1 | 0.1 | 0.1 | 0.1 |
| PETS | % | 0.2 | 0.2 | 0.2 | 0.2 |
| ION | % | 3 | 3 | 3 | |
| COL1 | % | 0.4 | 0.4 | 0.4 | 0.4 |
| GF | % | 30 | 30 | 30 | 30 |
| Total: | | 100.00 | 100.00 | 100.00 | 100.00 |
| DK at 1.9 GHz (0.75 | | 3.513 | 3.380 | 3.600 | 3.477 |
| mm thick part) | | | | | |
| DF at 1.9 GHz (0.75 | | 0.0095 | 0.0085 | 0.0087 | 0.0087 |
| mm thick part) | | | | | |
| MVR (Avg) (275 C./ | cm³/ | 116.0 | 124.1 | 49.7 | 76.4 |
| 5 kg/300 C.) | 10 min | | | | |
| Tensile Modulus (Avg) | MPa | 9372 | 9215 | 9102 | 9174 |
| Stress at Break (Avg) | MPa | 123.7 | 119.2 | 124.6 | 128.3 |
| Elongation at Break (Avg) | % | 2.4 | 2.4 | 2.2 | 2.2 |
| Flexural Modulus (Avg) | MPa | 8580 | 8380 | 8200 | 8380 |
| Flexural Stress at Yield (Avg) | MPa | 189 | 187 | 194 | 201 |
| Flexural Stress at Break (Avg) | MPa | 185 | 184 | 190 | 197 |
| Ductility | % | 0 | 0 | 100 | 100 |
| NII (room temp) (Avg) | J/m | 71.2 | 84.4 | 108 | 110 |
| Ductility | % | 0 | 0 | 0 | 0 |
| UNII (room temp) (Avg) | J/m | 671 | 750 | 959 | 946 |
| SG | | 1.54 | 1.52 | 1.51 | 1.50 |
| HDT (1.82 MPa, 3.2 mm) | ° C. | 205 | 206 | 185 | 191 |
| Mold shrinkage parallel (Avg) | % | 0.31 | 0.34 | 0.18 | 0.15 |
| Mold shrinkage perpendicular | % | 0.71 | 0.75 | 0.34 | 0.46 |
| (Avg) | | | | | |

More comparative examples are shown in Table 5, with an Utem™ PEI resin included as the second resin. Comparing E4 with C5/C6, it was observed that tensile stress, elongation, impact strength and mold shrinkage are all improved in the inventive composition. Comparing E4 with C7, which included the typical polyester impact modifying package, it was observed that the inventive composition had improved modulus (tensile and flexural), stress, impact, and mold shrinkage.

C8 and E5 are two other comparative examples using other mineral fillers (Zinc Sulfide and wollastonite). The overall performance of the inventive composition (E5) remains good.

TABLE 5
PEI as second resin

| Component/Property | Unit | C5 | C6 | E4 | C7 | C8 | E5 |
|---|---|---|---|---|---|---|---|
| PBT2 | % | 54.4 | 40.8 | 38.6 | 35.2 | 40.8 | 38.6 |
| PEI | % | | 13.6 | 12.8 | 11.7 | 13.6 | 12.8 |
| IRG | % | 0.1 | 0.1 | 0.1 | 0.1 | 0.1 | 0.1 |
| STAB1 | % | 0.25 | 0.25 | 0.25 | 0.25 | 0.25 | 0.25 |
| MZP | % | 0.05 | 0.05 | 0.05 | 0.05 | 0.05 | 0.05 |
| PETS | % | 0.2 | 0.2 | 0.2 | 0.2 | 0.2 | 0.2 |
| ION | % | | | 3 | | | 3 |
| IM | % | | | | 3 | | |
| HYT | % | | | | 2.5 | | |
| EEA | % | | | | 2 | | |
| COL2 | % | 20 | 20 | 20 | 20 | | |
| WOL | % | | | | | 20 | 20 |
| GF | % | 25 | 25 | 25 | 25 | 25 | 25 |
| Total: | | 100.0 | 100.0 | 100.0 | 100.0 | 100.0 | 100.0 |
| MVR (Avg) | cm³/10 | 124.7 | 68.6 | 39.4 | 28.2 | 50.2 | 27.1 |
| (275 C./5 kg/300 C.) | min | | | | | | |
| MVR (Avg) | cm³/10 | 264.6 | 139.1 | 86.1 | 49.8 | 79.8 | 65.3 |
| (275 C./5 kg/1080 C.) | min | | | | | | |
| Tensile Modulus (Avg) | MPa | 10600 | 10720 | 10209 | 9315 | 12245 | 12135 |
| Stress at Break (Avg) | MPa | 128.7 | 130.9 | 131.4 | 115.6 | 107.1 | 106 |
| Elongation at Break (Avg) | % | 2.2 | 1.7 | 2.1 | 2.2 | 1.8 | 1.7 |
| Flexural Modulus (Avg) | MPa | 9630 | 9840 | 9360 | 8490 | 10700 | 11300 |
| Flexural Stress at Yield | MPa | 201 | 192 | 195 | 173 | 166 | 164 |
| (Avg) | | | | | | | |
| NII (room temp) (Avg) | J/m | 65.2 | 65.2 | 76.3 | 79.8 | 50.1 | 56.5 |
| UNII (room temp) (Avg) | J/m | 751 | 714 | 816 | 766 | 457 | 518 |
| HDT (1.82 MPa, 3.2 mm) | ° C. | 205 | 177 | 163 | 173 | 124 | 160 |
| Mold shrinkage parallel | % | 0.31 | 0.24 | 0.32 | 0.23 | 0.24 | 0.22 |
| (Avg) | | | | | | | |
| Mold shrinkage | % | 0.74 | 0.53 | 0.33 | 0.46 | 0.37 | 0.38 |
| perpendicular (Avg) | | | | | | | |

Overall, it was observed that by combing some amorphous or low crystallinity speed resins with some processing aids such as low molecular weight ionomers, the overall performance can be balanced. Specifically modulus (tensile and/or flexural) can be maintained or improved, ductility can be increased, and impact performance can be improved. Further, mold shrinkage can be reduced and mold shrinkage is more uniform in two test directions. Finally, dielectric properties also can be improved; in particular dielectric dissipation factor can be lowered.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1-20. (canceled)

21. A composition comprising:
a. 20 wt % to 80 wt % of a first resin consisting of polybutylene terephthalate (PBT);
b. 1 wt % to 20 wt % of a second resin comprising polycarbonate (PC), polyetherimide (PEI), PEI-siloxane copolymer, a resorcinol-based aryl polyester having at least 40 mole % of its moieties derived from resorcinol, copolymers thereof or a combination thereof, wherein the second resin does not comprise polyethylene terephthalate (PET);
c. from 0.5 wt % to 10 wt % of a first processing aid comprising a low molecular weight ionomer; and
d. from 10 wt % to 60 wt % of a reinforcing filler,
wherein the composition comprises a tensile modulus of at least 3,000 MPa as tested in accordance with ASTM D638 and a notched Izod impact strength of at least 50 J/m as tested in accordance with ASTM D256 at room temperature.

22. The composition according to claim 21, wherein the PBT is a low viscosity PBT, a high viscosity PBT, or a combination thereof.

23. The composition according to claim 21, wherein:
the low molecular weight ionomer comprises an olefin backbone with one or more substituted salt groups attached to the olefin backbone;
the one or more salt groups comprise a carboxylate or sulphonate; and
the one or more salt groups are substituted with at least one metal cation.

24. The composition according to claim 23, wherein the at least one metal cation is selected from the group consisting of: sodium, zinc, lithium, potassium, magnesium, calcium, barium, copper and combinations thereof.

25. The composition according to claim 21, wherein the reinforcing filler comprises glass fiber, carbon fiber, basalt fiber or a combination thereof.

26. The composition according to claim 21, further comprising from greater than 0 wt % to 20 wt % of an impact modifier, a third polymer, or a combination thereof.

27. The composition according to claim 26, wherein the impact modifier and the third polymer comprise one or more of polyester ether elastomer, ethylene-glycidyl methacrylate copolymer (EGMA), ethylene-methyl acrylate with glycidyl methacrylate (EMAGMA), ethylene ethyl acrylate, polyethylene (PE), polypropylene (PP), polystyrene (PS), poly(p-phenylene oxide) (PPO), acrylonitrile butadiene styrene (ABS), styrene-ethylene-butadiene-styrene (SEBS), copolymers thereof, or a combination thereof.

28. The composition according to claim 21, further comprising from greater than 0 wt % to 30 wt % of a reinforcing agent or additional additive.

29. The composition according to claim 28, wherein the reinforcing agent comprises solid glass beads, hollow glass beads, mineral fillers, or a combination thereof.

30. The composition according to claim 29, wherein the mineral fillers comprise titanium dioxide, talc, mica, zinc sulfide, wollastonite, clay, or a combination thereof.

31. The composition according to claim 28, wherein the additional additive comprises a pigment, a second processing aid, a thermal stabilizer, a light stabilizer, an ultraviolet (UV)-resistance additive, a UV-absorbing additive, or a combination thereof.

32. The composition according to claim 31, wherein the second processing aid comprises a flow promoter, a de-molding agent or a combination thereof.

33. An article formed from the composition of claim 21.

34. The article according to claim 33, wherein the article is injection molded or extrusion molded.

35. The article of claim 33, wherein the article is a molded article.

36. A method of making a composition, the method comprising:
a. forming a mixture comprising
i. 20 wt % to 80 wt % of a first resin consisting of polybutylene terephthalate (PBT),
ii. 1 wt % to 20 wt % of a second resin comprising polycarbonate (PC), polyetherimide (PEI), PEI-siloxane copolymer, a resorcinol-based aryl polyester having at least 40 mole % of its moieties derived from resorcinol, copolymers thereof or a combination thereof, wherein the second resin does not comprise polyethylene terephthalate (PET),
iii. from 0.5 wt % to 10 wt % of a first processing aid comprising a low molecular weight ionomer, and
iv. from 10 wt % to 60 wt % of a reinforcing filler; and
b. injection molding or extruding the mixture to form the composition,
wherein the composition comprises a tensile modulus of at least 3,000 MPa as tested in accordance with ASTM D638 and a notched Izod impact strength of at least 50 J/m as tested in accordance with ASTM D256 at room temperature.

37. The method according to claim 36, wherein the PBT is a low viscosity PBT, a high viscosity PBT, or a combination thereof.

38. The method according to claim 36, wherein:
the low molecular weight ionomer comprises an olefin backbone with one or more substituted salt groups attached to the olefin backbone;
the one or more salt groups comprise a carboxylate or sulphonate; and
the one or more salt groups are substituted with at least one metal cation.

39. The method according to claim 38, wherein the at least one metal cation is selected from the group consisting of: sodium, zinc, lithium, potassium, magnesium, calcium, barium, copper and combinations thereof.

40. The method according to claim 36, wherein the reinforcing filler comprises glass fiber, carbon fiber, basalt fiber or a combination thereof.
